(19) United States
(12) Patent Application Publication
(10) Pub. No.: US 2026/0113698 A1
(43) Pub. Date: Apr. 23, 2026

(54) EFFICIENT RESOURCE ALLOCATION FOR DEVICES CONNECTED TO A FIXED WIRELESS ACCESS DEVICE

(71) Applicant: T-MOBILE INNOVATIONS LLC, Overland Park, KS (US)

(72) Inventor: Jasinder Pal SINGH, Olathe, KS (US)

(21) Appl. No.: 18/924,643

(22) Filed: Oct. 23, 2024

(51) Int. Cl. H04W 48/18; H04W 28/02

(52) U.S. Cl. CPC H04W 48/18; H04W 28/0226

(57) ABSTRACT

Methods, media, and systems are provided for assigning a network slice to a fixed wireless access (FWA) device based on devices served by the FWA device. It is determined that a first device is accessing a wireless communications network through an FWA device. A first network slice is then determined, the first network slice being associated with the first device. This first network slice is then allocated to the FWA device based on the first device accessing the network through the FWA device. The allocation of the first network slice may be based on device information and device type of the devices served by the FWA device. If this information changes, the network resources allocated to the devices served by the FWA device may also change.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to facilitating efficient resource allocation for one or more devices served by a Fixed Wireless Access (FWA) device, substantially as shown in and/or described in connection with at least one of the figures, and as set forth more completely in the claims.

In aspects set forth herein, and at a high level, the technology described herein relates to dynamically assigning network slices to a Fixed Wireless Access (FWA) device based on the devices it serves. The method begins by determining that a first device is accessing the wireless communications network through the FWA device. Once the connection is established, the system identifies a first network slice that is specifically associated with the device's requirements, such as bandwidth, latency, or quality-of-service (QoS) needs. Finally, the system allocates the first network slice to the FWA device, ensuring that the first device has access to the appropriate network resources based on its connection through the FWA device. This method allows for efficient management of network resources and ensures that devices connected to the FWA device receive optimal performance.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for assigning a network slice to an FWA device based on devices served by the FWA device, in accordance with aspects herein;

FIG. 2 illustrates an example flowchart for assigning a network slice to an FWA device based on devices served by the FWA device, in accordance with aspects herein;

FIG. 3 illustrates another example flowchart for assigning a network slice to an FWA device based on devices served by the FWA device, in accordance with aspects herein;

FIG. 4 illustrates another example flowchart for assigning a network slice to an FWA device based on devices served by the FWA device, in accordance with aspects herein; and

FIG. 5 depicts an example computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In recent years, the proliferation of wireless communication devices and the increasing demand for high-speed data services have necessitated the development of more efficient and flexible network management techniques. FWA devices have emerged as a critical component in providing high-speed internet access, particularly in areas where traditional wired infrastructure is either unavailable or cost-prohibitive. FWA devices serve as intermediaries, connecting multiple end-user devices to a wireless communications network.

One of the challenges faced by network operators is the efficient allocation of network resources to the various devices served by an FWA device. Network slicing, a technique that allows the creation of multiple virtual networks on a shared physical infrastructure, has been identified as a promising solution to this challenge. By assigning specific network slices to different devices based on their requirements, network operators can ensure optimal performance and resource utilization.

Aspects provided herein address the need for a method and system for assigning network slices to FWA devices based on the devices they serve. Aspects are provided for a mechanism for dynamically allocating network slices to an FWA device, taking into account the type and capabilities of the devices accessing the network through the FWA device. This approach not only enhances the overall data throughput but also ensures that the network resources are utilized efficiently.

As described herein, aspects are directed to the dynamic allocation of radio resources to a device, such as an FWA device, through the allocation of network slices. The allocation of radio resources through network slices is based on the types of devices and other device information associated with the devices served by the FWA device. For instance, when there are multiple slices and various types of user devices served by an FWA device, radio resources can be assigned to the FWA device in a more efficient fashion by understanding more about the devices served by the FWA device. If, for example, an FWA device is serving devices such as a reduced capability device (e.g., REDCAP device) or Internet of Things (IoT) device, there may not be a need to reserve resources for the FWA device, or at least less resources may be needed, and as such, the network slice allocated to the FWA device for that device may reflect that. In this case, the network, such as a node, can dynamically change the resource allocations and/or allocate a different network slice and help other user devices served by the node by allocating more slices to those other devices. Alternatively, if the FWA device is serving user devices with heavy usage and are best effort (BE) devices, for example, the resource allocation assigned may not be modified to help other user devices served by the node. But if the user device(s) served by the FWA device has heavy usage and a guaranteed bit rate (GBR), resource allocation for the FWA device may need to be modified, by way of the allocated network slice, to account for the heavy usage and GBR user device(s).

By way of background, FWA is a type of wireless communication technology that provides broadband internet access to fixed locations, such as homes, offices, and other buildings. Unlike traditional wired broadband services (e.g., DSL, cable, or fiber), FWA uses wireless radio links to connect end-users to the internet. This technology is particularly beneficial in rural or remote areas where laying down wired infrastructure is challenging and costly. The evolution of FWA technology has been driven by advances in wireless communication standards, including 4G LTE and, more recently, 5G. These advancements have significantly improved the bandwidth, latency, and reliability of FWA services, making them a viable alternative to wired broadband in many scenarios. The deployment of FWA has facilitated the bridging of the digital divide by providing high-speed internet access to underserved and unserved regions.

An FWA system primarily comprises two components: the base station (or access point) and the fixed wireless access device (also known as Customer Premises Equipment, or CPE). The base station is a central node that transmits and receives wireless signals to and from multiple FWA devices. It is connected to the core network and the internet backbone. The FWA device is installed at the user's premises. It communicates wirelessly with the base station to provide internet connectivity to the end-user devices, such as computers, smartphones, smart TVs, and other internet-enabled devices within the premises.

The FWA device serves as the intermediary between the user's internal network and the base station. It receives data from the base station and transmits it to the user's devices and vice versa. For optimal performance, FWA devices are usually installed in locations with clear line-of-sight to the base station, such as rooftops or external walls.

FWA devices (e.g., High Speed Internet (HINT) Devices) play a crucial role in the delivery of high-speed internet to fixed locations, especially in areas lacking traditional broadband infrastructure. The continuous exchange of detailed operational data between FWA devices and the base station ensures robust, reliable, and high-performance internet connectivity, thereby enhancing the overall user experience. As FWA technology continues to evolve, the integration of advanced data analytics and AI-driven network management will further optimize the performance and reliability of FWA systems.

Various components may be involved in FWA systems. For exemplary purposes only, some of these components may include a base station that acts as the central hub connected to the internet backbone, and is equipped with antennas to transmit and receive signals over a wide area. The FWA device itself may be installed at the user's premises (home, office, etc.), and it may communicates wirelessly with the base station. Further, the FWA device connects to internal devices through wired (Ethernet) or wireless (Wi-Fi) connections.

The operational workflow for FWA devices includes signal transmission from the base station to the FWA device. The base station emits radio signals that cover a defined service area. These signals carry data to and from the internet. The FWA device, equipped with an antenna, receives these radio signals. Optimal placement of the FWA device is crucial, often requiring line-of-sight to the base station to minimize signal obstruction and interference. The received signals are processed by the FWA device, converting the radio waves into digital data. This involves demodulation, error correction, and data decoding to ensure accurate and efficient data transfer. The processed data is distributed to internal devices (e.g., computers, smartphones, smart TVs) within the user's premises. This distribution can occur via Wi-Fi or Ethernet. For Wi-Fi distribution, the wireless signals within the premises allow mobile and stationary devices to connect without cables. For Ethernet, there are wired connections to devices that support or require stable, high-speed internet access. When a user device requests data (e.g., browsing the internet, streaming video), the FWA device aggregates this data and transmits it back to the base station. The FWA device modulates and encodes the data into radio signals suitable for transmission. The base station receives the data from the FWA device, processes it, and routes it to the appropriate destination on the internet. Responses from the internet are similarly processed and sent back to the FWA device, completing the data exchange cycle.

Modern FWA devices often use advanced antenna technologies, such as Multiple Input Multiple Output (MIMO) and beamforming, to enhance signal strength, range, and reliability. Moreover, FWA devices operate in licensed and unlicensed frequency bands, including sub-6 GHz and millimeter-wave (mmWave) frequencies. The choice of frequency band affects coverage, bandwidth, and penetration capabilities. FWA systems may implement QoS mechanisms to prioritize critical traffic, manage bandwidth allocation, and ensure consistent performance for various applications (e.g., video conferencing, online gaming). Data encryption and secure communication protocols protect user data from interception and unauthorized access. FWA devices can be remotely monitored and updated by service providers, ensuring they run the latest firmware and configuration settings for optimal performance and security.

Allocating radio resources for network slices, especially in the context of 5G networks, is a crucial aspect of ensuring performance, flexibility, and efficiency in next-generation wireless communications. Network slicing refers to the ability to create multiple virtual networks (or “slices”) on top of a shared physical network infrastructure. These slices are tailored to meet different service requirements (e.g., enhanced mobile broadband, massive IoT, ultra-reliable low-latency communications) and are assigned different resources to meet their specific needs. Key Concepts in Radio Resource Allocation for Network Slicing include Radio Resource Management (RRM), types of network slices, resource allocation approaches, radio resources in slicing, performance metrics, and techniques for radio resource allocation. RRM involves controlling and optimizing the radio resources available (like spectrum and bandwidth) to ensure efficient use. In network slicing, RRM ensures that each slice gets an appropriate share of the radio resources while meeting the service-level agreements (SLAs) for that slice. Regarding types of network slices, Enhanced Mobile Broadband requires high bandwidth and can tolerate some latency. It supports services like high-definition video streaming and augmented/virtual reality. Massive Machine-Type Communications focuses on low power and high connectivity density, suited for IoT devices, while Ultra-Reliable Low Latency Communications need extremely low latency and high reliability, suitable for mission-critical services like autonomous driving or remote surgery.

Resource Allocation Approaches include static allocation, dynamic allocation, and hybrid allocation. For static allocation, resources are pre-allocated to different slices based on predefined policies. While this guarantees resources for critical slices, it may lead to under-utilization of resources when the traffic demand is dynamic. For dynamic allocation resources are allocated dynamically based on real-time demand from each slice. This approach allows better utilization of resources but can be more complex to manage. Hybrid allocation is a combination of static and dynamic approaches, where a portion of resources is pre-allocated to ensure some baseline performance, and the rest are dynamically assigned based on demand.

Examples of radio resources in slicing include spectrum, or frequency bands allocated to the network and shared among the slices, time slots, such as time-division multiplexing, which is used to assign certain time slots to different slices for transmission, and power control, where power can be distributed among slices to optimize signal strength, reduce interference, and maintain quality of service (QoS). Further, key performance indicators (KPIs) for radio resource allocation may include, for exemplary purposes only, throughput, which is the amount of data transferred in a slice, latency, or the delay experienced in communication, reliability, which is the probability of successfully transmitting data, and resource utilization efficiency, or how effectively the resources are being used.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

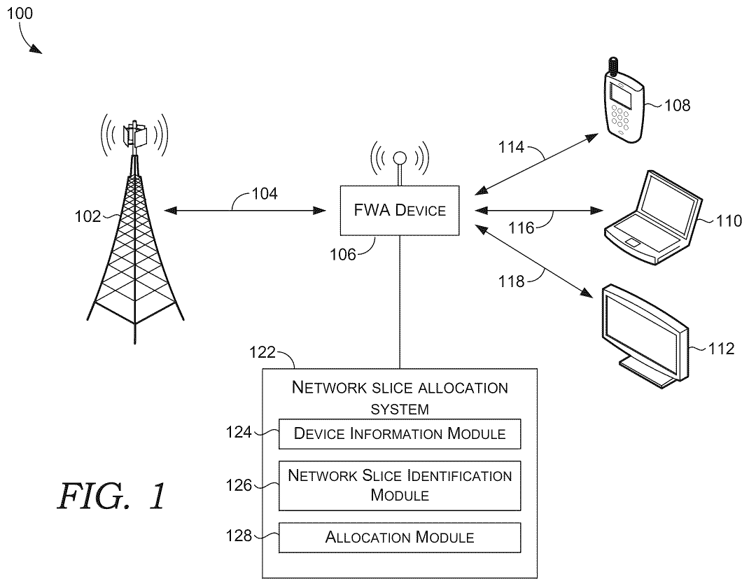

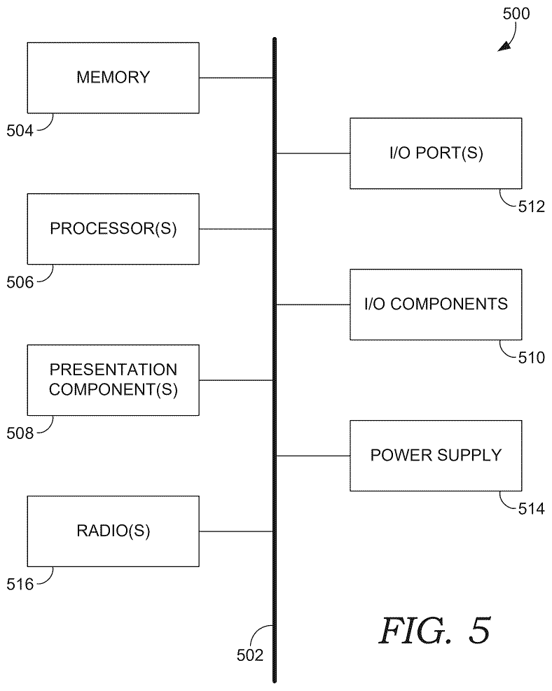

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user devices 108, 110, or 112 described herein with respect to FIG. 1. A user device may also be, in another embodiment, similar to user device 500, described herein with respect to FIG. 5.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1×Advanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

In a first aspect, a method is provided for assigning a network slice to an FWA device based on devices served by the FWA device. The method includes determining that a first device is accessing a wireless communications network through an FWA device, identifying a first network slice that is associated with the first device, and allocating the first network slice to the FWA device based on the first device accessing the network through the FWA device.

In a second aspect, a system is provided for assigning a network slice to a fixed wireless access (FWA) device based on devices served by the FWA device. The system includes a node having one or more antennas, the node being associated with a wireless telecommunication network, one or more processors communicatively coupled with the node, and computer memory storing computer-usable instructions that, when executed by the one or more processors, perform operations. The operations comprise receiving device type and device capability information for one or more devices served by the FWA device, determining that a first device of the one or more devices is accessing a wireless communications network through the FWA device, identifying a first network slice that is associated with the first device, and allocating the first network slice to the FWA device based on the first device accessing the network through the FWA device.

In a third aspect, one or more non-transitory computer storage media having computer-executable instructions embodied thereon are provided, that when executed by at least one processor, cause the at least one processor to perform a method. The method includes, at a fixed wireless access (FWA) device, determining device type and device capability information for one or more devices served by the FWA device, communicating the device type and the device capability information to the a node that serves the FWA device, and receiving an allocation of at least one network slice at the FWA device. The at least one network slice has a particular assignment of network resources based on the device type and the device capability information of the one or more devices served by the FWA device.

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for facilitating efficient resource allocation for devices served by an FWA device within a wireless telecommunications network. The system includes components and interactions between the FWA device and a network node to determine the number of connected devices, gather device-specific information, and communicate this information to optimize resource management. Network environment 100 includes node 102 (e.g., base station), an FWA device 106, and user devices 108, 110, and 112.

As mentioned, network environment 100 includes user devices 108, 110, and 112. In network environment 100, user devices 108, 110, and 112 may take on multiple forms, such as cameras, microphones, sensors, googles, and glasses, to name a few, or any other device (such as the computing device (500) that communicates via wireless communications with the FWA device 106 in order to interact with a public or private network.

In some aspects, each of the user devices 108, 110, and 112 may correspond to computing device 500 in FIG. 5. Thus, user device can include, for example, a display(s), a power source(s) (e.g., a battery), a data store(s), a speaker(s), memory, a buffer(s), a radio(s) and the like. In some implementations, for example, user devices 108, 110, and 112 comprise a wireless or mobile device with which a wireless telecommunication network(s) can be utilized for communication (e.g., voice and/or data communication). In this regard, the user devices 108, 110, and 112 can be any mobile computing device that communicates by way of a wireless network, for example, a 3G, 4G, 5G, 6G, LTE, CDMA, or any other type of network. In some cases, user devices 108, 110, and 112 in network environment 100 can optionally utilize one or more communication channels (not shown) to communicate with other computing devices (e.g., a mobile device(s), a server(s), a personal computer(s), etc.) through the FWA device 106 and node 102. Node 102 may be a gNodeB, eNodeB, or the like.

The network environment 100 may be comprised of a telecommunications network(s) (now shown), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

Communication channel 104 can be part of a telecommunication network that connects subscribers to their immediate telecommunications service provider (i.e., home network carrier). In some instances, such as when an FWA device is utilized, the communication channels are associated with a telecommunications provider that provides services (e.g., 3G network, 4G network, LTE network, 5G network, 6G network, and the like) to the FWA device, such as the FWA device 106. For example, the communication channels may provide voice, SMS, and/or data services to user devices 108, 110, and 112 through the FWA device 106, or corresponding users that are registered or subscribed to utilize the services provided by the telecommunications service provider. Some devices, such as user devices 108, 110, and 112, connect to the FWA device 106 and receive telecommunications services through this device. The communication channels can comprise, for example, a 1× circuit voice, a 3G network (e.g., CDMA, CDMA2000, WCDMA, GSM, UMTS), a 4G network (WiMAX, LTE, HSDPA), or a 5G network or a 6G network. The same communication channel 104 or a separate channel may also be used for the transmission of network slices from the network to FWA device 106.

In some implementations, node 102 is configured to communicate with user devices 108, 110, and 112 by way of the FWA device 106, which may be located in a same area as the user devices 108, 110, and 112. As such, radio antennas of node 102 may send communications to the FWA device 106, which then serves user devices 108, 110, and 112. Node 102 may include one or more base stations, base transmitter stations, radios, antennas, antenna arrays, power amplifiers, transmitters/receivers, digital signal processors, control electronics, GPS equipment, and the like.

The FWA device 106 provides device connectivity to the wireless network to user devices 108, 110, and 112 by way of, for example, communication links 114, 116, and 118. The FWA device 106 serves multiple end-user devices within a specific coverage area, providing broadband wireless connectivity. This device is equipped with components to determine the number of connected devices, request information from them, and communicate with node 102. In some aspects, when there is no traffic served by the FWA device 106, RACH procedure may be used to identify a quantity of user devices connected to the FWA device 106. In the RACH procedure, a user device may send an initial RACH (to access service from the node 102) with a particular nominal power given to the device. In aspects herein, if the FWA device 106 is serving one user device, the FWA Device 106 will use the nominal power given to it. If there are two user devices, the FWA device 106 may send a message with nominal power offset by 1 dbm, for example (e.g., x+1 dbm), and if serving two user devices, the nominal power would be offset with 2 dbm, and so on. This will allow the node 102 to know how many user devices are being served by the FWA device 106, allowing the node 102 to more efficiently plan resources. Once the user devices are connected, the FWA device 106 may request user device capabilities from each connected user device, such as user devices 108, 110, and 112 in FIG. 1. This information is then sent to the node 102, such as by communication channel 104. This device capability information may be communicated to the node 102 in a new message, not currently sent to the node 102 in current aspects, or, the device capability information may be added to an existing message, such as a message sent by the FWA device 106 that includes the device capability information of that FWA device 106. Either way, the capability information may now be sent to the node 102, where previously this information was not sent to or known by the node 102. Knowing this information may help the node 102 to optimize other features of resource allocation by the network.

Integrated within the FWA device or separate from the FWA device is a network slice allocation system 122. While network slice allocation system 122 may not be the component allocating resources and network slices, it is collecting information and sending this information to the network for dynamic and efficient network slicing allocation. This system enables the allocation of specific network slices to the FWA device, allowing efficient management of network resources based on the devices it serves. The FWA device 106 is equipped with three key modules: the Device Information Module 124, the Network Slice Identification Module 126, and the Allocation Module 128, which work together to ensure the correct allocation of network slices to devices connected to the FWA device.

Device information module 124 is responsible for collecting and processing device information from the devices connected to the FWA device 106. Device information may include data such as device type, capabilities, and current usage. Device information module 124 gathers the device-specific data that is used for identifying the appropriate network slice. The information gathered may include, for exemplary purposes only, device type (e.g., mobile or non-mobile, Internet of Things (IoT) or non-IoT), bandwidth requirements, signal strength, latency sensitivity, beamforming capability (e.g., MIMO), supported features on the device, new radio (NR) capability, throughput maximum, carrier aggregation capability, and current usage patterns. This data is then forwarded to the Network slice identification module 126.

Network slice identification module 126 identifies the appropriate network slice based on the device information provided by the device information module 124. Each network slice is typically configured for specific quality-of-service (QoS) requirements or other characteristics that match the needs of the connected devices. Network slice identification module 126 ensures that the correct network slice is selected based on the unique requirements of each device, such as latency, bandwidth, or priority. For instance, a different network slice or different network resources may be allocated if one or more of the devices served by the FWA device 106 has a guaranteed bit rate (GBR), or if the device is a best effort (BE) device. Alternatively, a different network slice or different network resources may be allocated if one or more of the devices served by the FWA device 106 is an IoT device that requires less network resources than other devices.

Once the appropriate network slice has been identified, or once the appropriate network resource have been determined, allocation module 128 is responsible for allocating that slice to the FWA device 106. This process involves assigning the network resources, as represented by the selected slice, to support communication between the devices connected to the FWA device and the broader wireless network. The allocation module ensures the proper delivery of network resources, optimizing data traffic and maintaining the required quality of service for the connected devices.

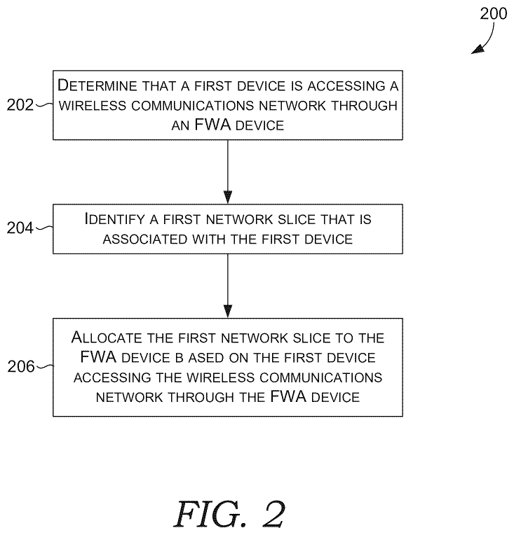

FIG. 2 illustrates an example flowchart of a method 200 for assigning a network slice to an FWA device based on devices served by the FWA device, in accordance with aspects herein. At block 202, it is determined that a first device is accessing a wireless communications network through an FWA device. This step involves detecting when the first device establishes a connection to the wireless network via the FWA device. The system monitors for incoming connection requests or network activity from the device, signaling that it is utilizing the FWA device to access the network. In addition to the first device, it may be detected that a second device is accessing the wireless communications network via the FWA device. This detection allows the system to manage multiple devices connected to the network through the FWA device. The second device's characteristics and service requirements may also be analyzed, and based on these, a second network slice suitable for serving the second device's needs may be identified. The identified second network slice is then allocated to the FWA device to handle the data traffic and performance requirements of the second device, ensuring efficient use of network resources.

A direct link is established between the FWA device and a network node (e.g., a base station) for transmitting data based on the first network slice. This link is configured to carry traffic between the first device and the wireless communications network, ensuring that the device can access the allocated network resources. A second link may then be established between the FWA device and the network node to carry data for the second device, based on the second network slice. This ensures that the second device also has a dedicated communication path optimized for its performance needs. In some aspects, carrier aggregation may be used, which is a technique where multiple links (first and second links) are combined to increase the overall data transmission capacity between the FWA device and the network node. This aggregation enables the FWA device to utilize both network slices simultaneously, improving the overall data throughput and performance of the system.

In aspects, data traffic generated by the first device is continuously monitored. Based on this traffic, the network, for example, may dynamically adjust the allocation of network resources (e.g., bandwidth, latency parameters) within the first network slice to optimize the performance for the device. This dynamic adjustment process is influenced by real-time factors such as current network conditions (e.g., congestion, available capacity) and the data traffic requirements of the first device. This ensures that the system can adapt to fluctuating conditions and maintain an efficient allocation of resources. As described herein, the FWA device is designed with the capability to support multiple network slices at the same time. This allows it to serve different devices or services concurrently, each utilizing its own allocated slice, thereby improving network efficiency and device performance. In some aspects, the network prioritizes the allocation of network slices based on the type of service being accessed by the devices (e.g., video streaming, real-time gaming, IoT communication). Services that require lower latency or higher bandwidth may be allocated network slices with higher performance characteristics, ensuring a smooth and uninterrupted user experience.

In aspects, when the first device disconnects from the wireless network or ceases to require access through the FWA device, the system deallocates the first network slice. This releases the network resources associated with the slice, making them available for other devices or services, thereby improving overall resource utilization.

At block 204, once the device's access has been determined, a first network slice is identified that is associated with the first device. The identification process evaluates the specific needs of the device, such as bandwidth requirements, latency sensitivity, or other performance-related parameters. The system then selects the most suitable network slice, which is designed to meet the device's service or quality-of-service (QoS) requirements.

At block 206, the first network slice is allocated to the FWA device based on the first device accessing the wireless communications network through the FWA device. This allocation ensures that the resources associated with the identified network slice are assigned to the FWA device, allowing the first device to communicate effectively with the network. The allocation of the network slice ensures that the device's connection is optimized for its specific use case, improving overall performance and network efficiency. While traditionally, the network slice would be allocated directly to the device who is needing the network resources, here, it is allocated to the FWA device. Additionally, while typically FWA devices are blindly allocated network slices and otherwise allocated network resources, here, the allocation is dynamic and intelligent, taking into account device information associated with the devices served by the FWA device.

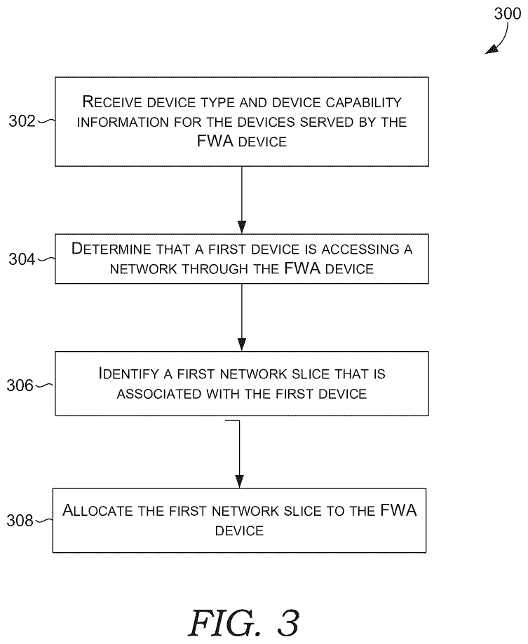

Turning now to FIG. 3, FIG. 3 illustrates another example flowchart of a method 300 for assigning a network slice to an FWA device based on devices served by the FWA device, in accordance with aspects herein. At block 302, device information is received for one or more devices served by the FWA device. This information may include, but is not limited to, details regarding the type of device (e.g., smartphone, IoT device, tablet), its network capabilities (e.g., 4G, 5G, MIMO capabilities), supported bandwidth, latency requirements, and maximum throughput. The FWA device collects this information from each connected device and forwards it to the network control system to facilitate resource management. The collected data serves as the basis for identifying the network slice that will best meet the device's performance needs.

At block 304, it is determined that a first device of the one or more devices is accessing a wireless communications network through the FWA device. This step involves monitoring the FWA device's communication interfaces and identifying when a specific device attempts to connect to or interact with the wireless network. The determination is made by observing the device's network activity or by receiving connection signals indicating the device is active and requires access to the wireless network. At block 306, a first network slice is identified that is associated with the first device. This identification is based on the device's characteristics, as received at block 302, and its specific requirements for network performance, such as bandwidth, latency, or quality-of-service (QoS) parameters. The system selects the network slice that is configured to meet the device's requirements, ensuring that the device will have sufficient network resources for optimal operation. At block 308, the first network slice is allocated to the FWA device based on the first device accessing the network through the FWA device. This involves assigning the network resources associated with the identified network slice to the FWA device, allowing the first device to utilize the network with the appropriate level of service. The allocation ensures that the first device is served by a network slice specifically tailored to its needs, thereby optimizing its performance on the wireless network. The allocation process dynamically responds to the device's access and adjusts the network resources accordingly.

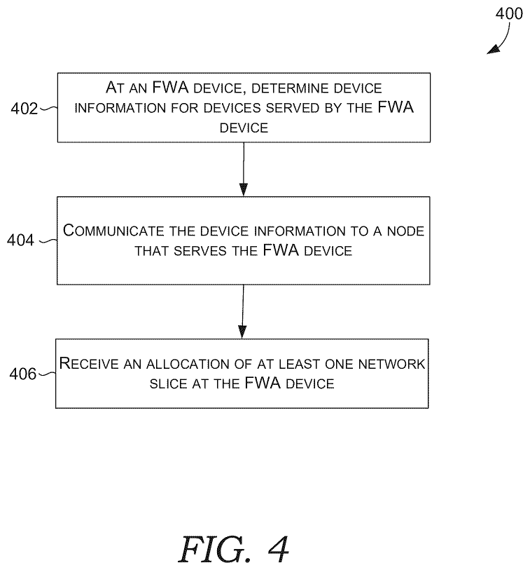

FIG. 4 illustrates another example flowchart of a method 400 for assigning a network slice to an FWA device based on devices served by the FWA device, in accordance with aspects herein. At block 402, information is determined for one or more devices served by the FWA device. This information may include, but is not limited to, device type, device capability (e.g., bandwidth requirements, supported communication protocols such as 4G/5G, MIMO configurations, latency sensitivity), and usage data (e.g., current throughput, service type). The FWA device collects this data for each device connected to it. The gathered information is used for determining the appropriate network slice that should be allocated to the FWA device for managing network traffic effectively. The device type, in aspects, may include, for instance, whether a device is an IoT device or a non-IoT device. In other aspects, device type could be smartphones and tablets, laptops and desktop computers, smart televisions and streaming devices, smart home devices, gaming consoles, wearable devices, printers and scanners, all types of IoT devices (e.g., Internet-connected sensors, appliances, and other gadgets used for various purposes like home automation, health monitoring, and industrial applications), VoIP phones, Virtual Reality (VR) and Augmented Reality (AR) Devices, network storage devices, connected vehicles, smart appliances, medical devices, industrial and commercial equipment, and the like.

At block 404, the device information is communicated to a node that serves the FWA device. The node, which may be part of a larger wireless telecommunications network, acts as a central coordinator for managing network resources, including network slices. The FWA device transmits the collected information to the node, enabling it to assess the specific needs of the devices connected to the FWA device. This communication ensures that the node has real-time access to data about the devices' capabilities and requirements, which is essential for optimizing the allocation of network resources.

At block 406, the FWA device receives an allocation of at least one network slice, where each network slice has a particular assignment of network resources based on the device information of the one or more devices served by the FWA device. The allocated network slice is customized to meet the performance needs of the connected devices, such as ensuring sufficient bandwidth, prioritizing certain types of data traffic, or minimizing latency for time-sensitive applications. The network slice is dynamically allocated to the FWA device based on the real-time device information, ensuring that network resources are utilized efficiently, and each device experiences optimal performance on the network. The system continuously monitors the devices connected to the FWA device. During this monitoring, the system may detect any changes in the type or capabilities of the connected devices. Such changes could include the addition of new devices with different capabilities or modifications in the features of existing devices (e.g., software updates that change network performance). Upon detecting a change in device type or capabilities, the system determines whether the current network slice allocation remains optimal for the new device configuration. If not, the system receives an indication from the network management system that the network slice has been reassigned or reconfigured with a different set of network resources. This reallocation ensures that the network slice continues to meet the performance requirements of the updated devices. The reallocation may include changes to bandwidth, latency, or other quality-of-service (QoS) parameters.

A change in device information, as described above, may specifically include a scenario where one or more of the connected devices now requires a Guaranteed Bit Rate (GBR). GBR devices have strict requirements for a minimum guaranteed level of bandwidth and other performance metrics, as required by real-time applications such as video streaming, voice over IP (VOIP), or online gaming. Upon detecting that one of the devices requires a GBR, the FWA device may receive adjusted network resources, or a different/modified network slice to ensure that the required resources (such as bandwidth or prioritized latency handling) are allocated to meet the device's guaranteed bit rate. This ensures that the performance demands of GBR devices are consistently met, even when network conditions fluctuate. In other aspects, a change in device information may indicate that a lesser amount of network resources are needed. This could occur, for example, when there are no GBR devices, and the devices are IoT devices and others that do not have a significant throughput.

Having described the example embodiments discussed above of the presently disclosed technology, an example operating environment of an example user device (e.g., user device 102A of FIG. 1) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 514, and one or more radios 516.

Bus 502 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 506 can execute instructions, for example, of an operating system of the user device 500 or of one or more suitable applications.

The one or more presentation components 508 can present data indications via user device 500, another user device, or a combination thereof. Example presentation components 508 may include a display device, speaker, printing component, vibrating component, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 508 can present a visualization that compares a plurality of inspections of one or more cores of a central processing unit and a visualization of each task of each of the plurality of inspections.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 508 of the user device 500 to render immersive augmented reality or virtual reality.

The power supply 514 of user device 500 may be implemented as one or more batteries or another power source for providing power to components of the user device 500. In embodiments, the power supply 514 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 516 (or similar wireless communication components). The one or more radios 516 can transmit, receive, or both transmit and receive signals for wireless communications. In embodiments, the user device 500 may be a wireless terminal adapted to receive communications and media over various wireless networks. User device 500 may communicate using the one or more radios 516 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 516 may facilitate communication via radio frequency signals, frames, blocks, transmission streams, packets, messages, data items, data, another type of wireless communication, or one or more combinations thereof. The one or more radios 516 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for assigning a network slice to a fixed wireless access (FWA) device based on devices served by the FWA device, the method comprising:
determining that a first device is accessing a wireless communications network through an FWA device;
identifying a first network slice that is associated with the first device; and
allocating the first network slice to the FWA device based on the first device accessing the wireless communications network through the FWA device.

2. The method according to claim 1, further comprising:
determining that a second device is accessing the wireless communications network through the FWA device;
identifying a second network slice that is associated with the second device; and
allocating the second network slice to the FWA device based on the second device accessing the network through the FWA device.

3. The method according to claim 1, further comprising establishing a first link between the FWA device and a node associated with the wireless communications network based on the first network slice.

4. The method according to claim 3, further comprising establishing a second link between the FWA device and a node associated with the wireless communications network based on the second network slice.

5. The method according to claim 4, further comprising performing carrier aggregation between the first link and the second link, wherein the first link and the second link are used concurrently for data transmission, thereby enhancing the overall data throughput between the FWA device and the node associated with the wireless communications network.

6. The method according to claim 1, further comprising receiving device information for the first device from the FWA device, the device information comprising at least one of device capability information or device type.

7. The method of claim 1, further comprising monitoring data traffic of the first device to dynamically adjust an allocation of network resources corresponding to the first network slice.

8. The method of claim 7, wherein the dynamic adjustment is based on current network conditions and data traffic requirements of the first device.

9. The method of claim 1, wherein the FWA device is configured to support multiple network slices simultaneously.

10. The method of claim 1, further comprising prioritizing an allocation of network slices to the FWA device based on a type of service being accessed by the devices served by the FWA device.

11. The method of claim 1, further comprising deallocating the first network slice from the FWA device when the first device ceases to access the wireless communications network through the FWA device.

12. A system for assigning a network slice to a fixed wireless access (FWA) device based on devices served by the FWA device, the system comprising:
a node having one or more antennas, the node being associated with a wireless telecommunication network;
one or more processors communicatively coupled with the node; and
computer memory storing computer-usable instructions that, when executed by the one or more processors, perform operations comprising:
receiving device information for one or more devices served by the FWA device;
determining that a first device of the one or more devices is accessing a wireless communications network through the FWA device;
identifying a first network slice, based on the device information, that is associated with the first device; and
allocating the first network slice to the FWA device based on the first device accessing the network through the FWA device.

13. The system according to claim 12, wherein the device information comprises at least one of a quantity of component carriers that can be aggregated, a maximum throughput, multiple-in-multiple-out (MIMO) capabilities, or supported features.

14. The system of claim 12, wherein the operations further comprise:
determining a second device of the one or more devices is accessing the wireless communications network through the FWA device;
identifying a second network slice that is associated with the second device; and
allocating the second network slice to the FWA device based on the second device accessing the wireless telecommunication network through the FWA device.

15. The system of claim 12, wherein the operations further comprise monitoring data traffic of the first device to dynamically adjust an allocation network resources corresponding to the first network slice.

16. The system of claim 12, wherein the operations further comprise prioritizing an allocation of network slices based on a type of service being accessed by the devices served by the FWA device.

17. The system of claim 12, wherein the operations further comprise deallocating the first network slice from the FWA device when the first device ceases to access the wireless telecommunication network through the FWA device.

18. One or more non-transitory computer storage media having computer-executable instructions embodied thereon, that when executed by at least one processor, cause the at least one processor to perform a method comprising:
at a fixed wireless access (FWA) device, determining information for one or more devices served by the FWA device;
communicating the device information to a node that serves the FWA device; and
receiving an allocation of at least one network slice at the FWA device, the at least one network slice having a particular assignment of network resources based on the device information of the one or more devices served by the FWA device.

19. The one or more non-transitory computer storage media of claim 18, further comprising:
determining a change in the device type and the device capability information for the one or more devices served by the FWA device; and
based on the change in the device type and the device capability information for the one or more devices served by the FWA device, receiving an indication that the network slice has a different assignment of network resources.

20. The one or more non-transitory computer storage media of claim 19, wherein the change corresponds to at least one device having a guaranteed bit rate (GBR).
